(19) United States
(12) Patent Application Publication
(10) Pub. No.: US 2006/0208666 A1
(43) Pub. Date: Sep. 21, 2006

(54) Electronic lighting device for simulating a flame

(76) Inventor: David C. Johnson, San Diego, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/373,791

(22) Filed: Mar. 10, 2006

Related U.S. Application Data
(60) Provisional application No. 60/662,915, filed on Mar. 16, 2005.

(51) Int. Cl. H05B 37/02; H01K 1/62; H05B 41/36

(52) U.S. Cl. 315/294; 315/51; 315/312

(57) ABSTRACT

An electronic lighting device for, and method of, simulating a flame comprises a plurality of light emitting devices coupled to control circuitry, which is configured to generate a plurality of control signals for controlling the periodicity of illumination and intensity of illumination of the plurality of light emitting devices. The control circuitry may be further configured to control the illumination of the plurality of electronic lighting devices to produce a plurality of lighting effects, wherein the effects may be random, predetermined, or a combination thereof.

### PRIORITY CLAIM

This application claims priority under 35 U.S.C. § 119(e) to U.S. Provisional Application No. 60/662,915 filed Mar. 16, 2005, entitled “ELECTRONIC LIGHTING DEVICE FOR SIMULATING A FLAME,” and which is incorporated herein by reference in its entirety.

### BACKGROUND OF THE INVENTION

1. Field of the Invention

The invention is generally related to an electrical lighting apparatus and, more specifically, to such a device configured to simulate a flame. More particularly, the invention relates to a device and method for electronically simulating a natural flame, for example, a candle flame.

2. Description of the Related Art

Various electrical devices have been developed to simulate a candle or natural flame for decorative purposes. U.S. Pat. No. 4,510,556 to Johnson describes and illustrates an exemplary electronic lighting apparatus for simulating a flame. Many of the known flame simulation devices are simplistic in nature and fail to create a realistic simulation effect. The characteristic appearance of a natural flame arises from certain illumination intensity variations and gas turbulence effects which are not easily reproduced in simple lighting devices of the type previously known. Known devices attempt to reproduce these effects using multi-filament light bulbs or a plurality of light-emitting diodes. These bulbs or diodes flicker on and off in random configurations. There has not been previously available, however, a lighting apparatus containing multiple lighting elements which are controlled so as to flicker in a manner according to a predefined pattern to more realistically simulate both the gas turbulence and the illumination intensity distribution that are characteristic of a burning flame.

### SUMMARY OF THE INVENTION

An electronic lighting device configured to simulate a natural flame comprises a plurality of light emitting devices, control circuitry coupled to the plurality of light emitting devices and configured to control the illumination of the plurality of light emitting devices to produce a plurality of lighting effects, wherein the plurality of lighting effects are configured to produce at least a first lighting effect, and a second, different lighting effect in sequence, wherein the sequence is repeated. The sequence may have a predetermined time duration comprising a predetermined time duration for the first lighting effect and a predetermined time duration for the second lighting.

The control circuitry may be coupled to a selection device such that the lighting effect produced is selectable by a user, and the selection device may be a switch having a plurality of user selectable positions.

The plurality of light emitting devices may be arranged in a substantially vertical configuration, and in one embodiment, the illumination intensity of an uppermost light emitting device is less than the illumination intensity of a lower light emitting device. In addition, the control circuitry may be configured to control the illumination of the plurality of light emitting devices such that an uppermost light emitting device is illuminated less frequently than a lower light emitting device.

In some embodiments, a subset of the plurality of light emitting devices is configured for illumination in response to signals from the control circuitry. The plurality of light emitting devices may comprise at least two subsets of light emitting devices, wherein illumination of each subset of light emitting devices simulates at least two natural flames.

A method of simulating a natural flame comprises periodically illuminating a plurality of light emitting devices to produce a plurality of lighting effects, wherein the plurality of lighting effects comprises at least a first lighting effect and a second, different lighting effect in sequence, wherein the sequence is repeated.

The lighting effect may be selected, and a switch having a plurality of user selectable positions may be used to select the lighting effect.

The plurality of light emitting devices may be arranged in a substantially vertical configuration, and the illumination intensity of an uppermost light emitting device may be less than the illumination intensity of a lower light emitting device. In addition, the uppermost light emitting device may be illuminated less frequently than a lower light emitting device. The sequence may have a predetermined time duration comprising a predetermined time duration for the first lighting effect and a predetermined time duration for the second lighting.

The method may further comprise simulating a plurality of natural flames, wherein the plurality of light emitting devices comprises a plurality of subsets of light emitting devices, wherein each subset of light emitting devices is configured to simulate a natural flame, and wherein the method further comprises illuminating each subset of light emitting devices to produce a plurality of lighting effects at each subset.

In some embodiments of the method, a subset of the plurality of light emitting devices are illuminated to produce the plurality of lighting effects.

### BRIEF DESCRIPTION OF THE DRAWINGS

The accompanying drawings are incorporated in and constitute a part of the specification. The drawings merely illustrate various aspects of certain embodiments of the invention, and are not meant to limit the scope of the disclosure. Rather, the accompanying drawings are provided for the purpose of assisting in the understanding of the disclosure.

FIG. 1 is an illustration depicting one embodiment of an electronic lighting device simulating a flame.

FIG. 2 depicts a block diagram of the electronic lighting apparatus of FIG. 1.

FIG. 3 depicts an electrical schematic block diagram of one embodiment of a circuit configured to control the illumination of the light emitting devices of an electronic lighting device such as the device of FIG. 1.

FIGS. 4A-C depict exemplary timing diagrams illustrating a plurality of control signals generated by a circuit, such as that of FIG. 3, for controlling the illumination of the light emitting devices of the electronic lighting device such as the device of FIG. 1.

FIG. 5 depicts a specific timing diagram illustrating a flicker lighting effect.

FIG. 6 depicts exemplary timing diagrams illustrating, respectively a light emitting device control signal, a pulse width modulated signal, and a signal comprising the sum of the light emitting device control signal and the pulse width modulated signal.

FIG. 7 depicts a specific timing diagram illustrating a sequential lighting effect comprising three flicker lighting effects.

### DETAILED DESCRIPTION OF THE PREFERRED EMBODIMENT

Embodiments are described with reference to the accompanying Figures, wherein like numerals refer to like elements throughout. The terminology used in the description presented herein is not intended to be interpreted in any limited or restrictive manner simply because it is being utilized in conjunction with a detailed description of certain specific embodiments of the invention. Furthermore, embodiments of the invention may include several novel features, uses or advantages, no single one of which is solely responsible for its desirable attributes and no single one of which is essential to practicing the described devices and methods.

As used herein, the term “light emitting device” as used herein includes any device or material capable of emitting light including, but not limited to, UV, infrared and visible light or, a combination thereof, of whatever wavelength, band, distribution or intensity. The term “control circuitry” as used herein refers to an electrical component or combination of electrical components, and may include analog components, digital components, and combinations thereof. The term “repetition” as used herein has its ordinary meaning, encompasses a single or multiple repetitions, and is not limited to an particular or predefined number of repetitions or iterations. The term “periodically” as used herein refers to an occurrence at regular or predictable intervals of time, and is preferably not limited to occurrences where the intervals of time are equal or substantially equal in duration. The term “sequence” as used herein refers to a substantially continuous connected series or succession and may include as few as two components. The term “different” as used herein has its ordinary meaning and encompasses even apparently minor or trivial differences or distinctions.

Described herein are devices configured to stimulate a natural flame and methods of simulating a natural flame. Lighting effects may be generated electronically with control circuitry coupled to a plurality of light emitting devices (which is meant to encompass a single, multi-source light emitting device). The light emitting devices may be arranged in a variety of arrangements and may be controlled, via control circuitry which, in turn maybe be controlled by user-controlled switches. The light emitting dev8ices are capable of producing a plurality of lighting effects and these effects may be configured to produce at least a first and a second, different, lighting effect in sequence. The sequence of lighting effects may be repeated.

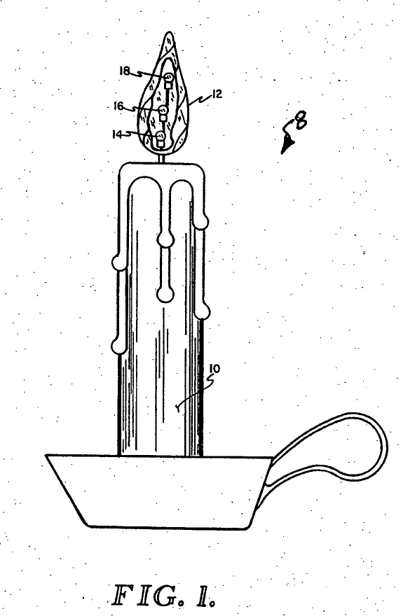

FIG. 1 is an illustration of one embodiment of an electronic lighting device 8. The electronic lighting device 8 comprises a substantially tubular housing 10 configured to resemble a candle and enclose substantially all of the electronic circuitry for operation of the device. The housing 10 may comprise, for example, plastic, metal, wax, rubber, or other suitable, durable material and any combination thereof.

The electronic lighting device 8 further comprises a flame body 12 affixed to an end of the tubular housing 10, wherein the flame body 12 has an elongated free-form shape generally resembling that of a candle flame. The flame body may have other shapes such as rectangular, spherical, triangular, conical, cylindrical, etc. The flame body 12 is substantially translucent and configured to support a plurality of light emitting devices in a cavity or plurality of cavities within the flame body 12. Enclosed within the flame body 12 are three light emitting devices 14, 16, 18 which are positioned in a spaced-apart, substantially vertical arrangement. The light emitting devices 14, 16, 18 can be, for example, light-emitting diodes (LED's), incandescent light bulbs, neon light bulbs, light emitting filaments, or any other device configured to emit UV, visible or infrared light. The lower light emitting device 14 is positioned near the base of the flame body 12, the middle light emitting device 16 is positioned above the lower light emitting device 14, and the upper light emitting device 18 is positioned near the upper end of the flame body 12. As will be discussed in further detail hereinafter below, each of the light emitting devices 14, 16, 18 are driven by control signals generated by circuitry substantially contained within the housing 10. The controls signals are timed such that the light emitting devices increase and decrease in lighting intensity in a manner which simulates both the gas turbulence and the illumination intensity distribution of a natural flame.

Persons skilled in the art will appreciate that the electronic lighting device 8 may include greater or fewer light emitting devices than three described for FIG. 1. For example, two, four, five, six or more light emitting devices are contemplated. In addition, the configuration of the light emitting devices is not limited to the vertical arrangement described and illustrated, but may include, for example, a plurality of light emitting devices positioned along horizontal, diagonal or other axes, or positioned along a plurality of axes and planes so as to simulate larger or more complex flames. In certain embodiments, the electronic lighting device includes a plurality of light emitting devices wherein only a predetermined subset of the total number of light emitting devices are configured for illumination. For example, an electronic lighting device may comprise six light emitting devices wherein only three of the six light emitting devices are configured for illumination.

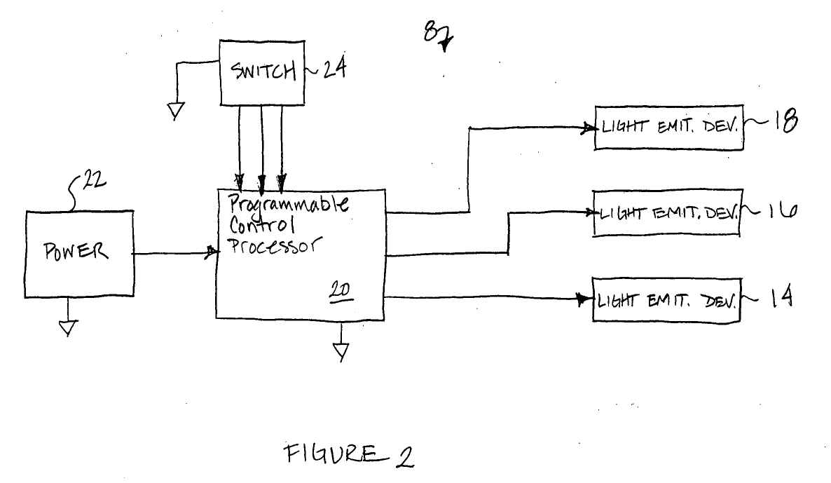

FIG. 2 is a block diagram of one embodiment of the electronic lighting device 8 of FIG. 1. The electronic lighting device 8 comprises a programmable control processor 20 coupled to the light emitting devices 14, 16, 18 and configured to control the illumination of the light emitting devices 14, 16, 18. The programmable control processor 20 is coupled to a power source 22, such as a battery, and a switch 24. In the embodiment illustrated in FIG. 2, the switch 24 comprises three individual selectors each having two positions. Accordingly, the switch 24 is capable of eight different positions. The programmable control processor 20 is configured to output control signals to the light emitting devices 14, 16, 18 according to the positions of the switching selectors at the switch 24. Thereby, a user may select between eight different lighting effects by selecting the positions of each of the individual selectors of the switch 24. As will be appreciated by persons skilled in the art, a switch having more or less selectors than three are within the scope of the invention and the switch described herein is exemplary in nature.

One embodiment of an electronic lighting device may be configured to emulate more than one flame, wherein, for example, the electronic lighting device comprises six light emitting devices and each flame consists of three light emitting devices such that the electronic lighting device emulates two flames. Each set of three light emitting devices may be controlled using the same set of control signals or a different set of three control signals. Furthermore, a plurality of flames, such as for a candelabra, may be emulated with a plurality of sets of light emitting devices, wherein the light emitting devices for each flame may be controlled with the same set of control signals or a different set of control signals.

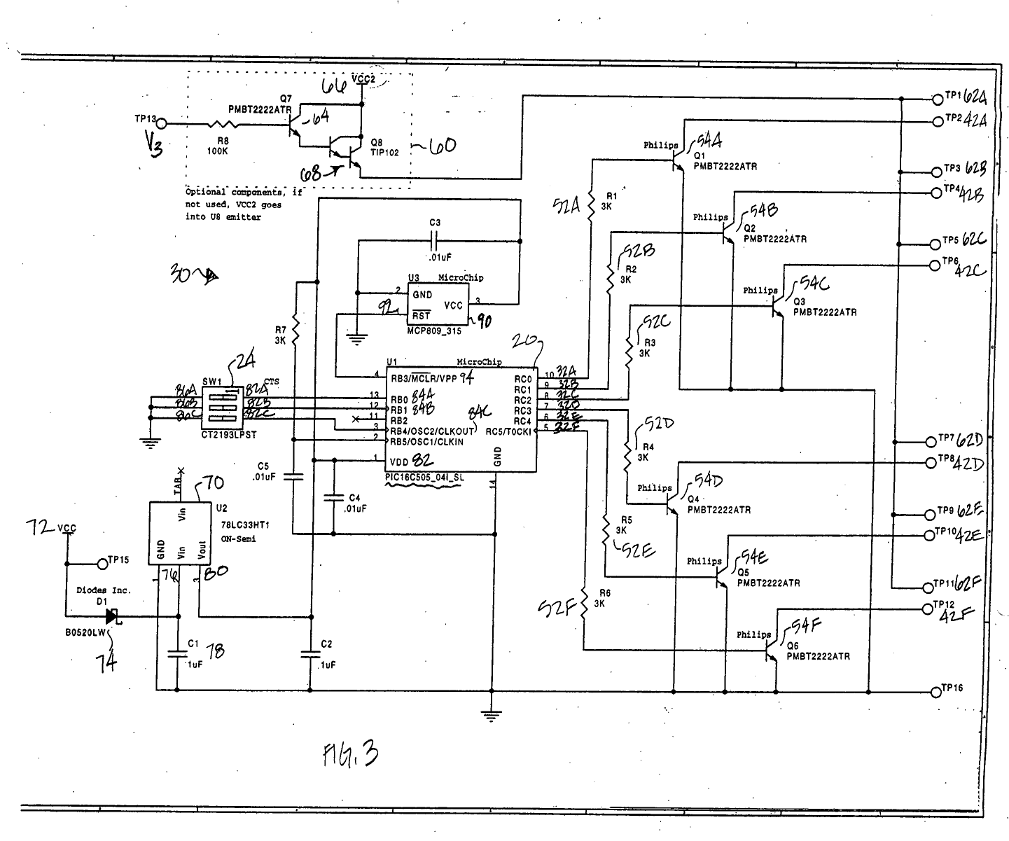

FIG. 3 is an electrical schematic of one embodiment of a control circuit 30 for the electronic lighting device 8. The control circuit 30 may be incorporated onto a single printed circuit board of suitable dimensions for housing in the substantially tubular housing 10 of the electronic lighting device illustrated in FIG. 1. In the control circuit 30, the programmable control processor 20 is implemented with a programmable integrated circuit such as the Microchip PIC16C505 CMOS Microcontroller. The programmable control processor 20 comprises a plurality of signal output terminals 32A-F, each coupled to a respective light emitting device output terminal 42A-F. As illustrated and described herein, the control circuit 30 is configured for connection to six light emitting devices at terminals 42A-F and terminals 62A-F. However, the number of light emitting devices coupled to the control circuit can be greater or less than six, and may include three light emitting devices such as illustrated in FIG. 2.

Coupled between each signal output terminal 32A-F of the programmable control processor 20 and light emitting device output terminal 42A-F may also be a respective resistor R1-R6 52A-F and transistor Q1-Q6 54A-F. Specifically, a first signal output 32A from the programmable control processor 20 is coupled through resistor R1 52A to a base of transistor Q1 54A, the collector of transistor Q1 54A is coupled to the first light emitting device output terminal 42A, and the emitter of transistor Q1 54A is coupled to ground. Transistors Q1-Q6 54A-F may be implemented, for example, with NPN bipolar junction transistors (BJT's), such as the Philips Semiconductor PMBT222. Resistors R1-R6 52A-F may be implemented with resistors having a value of about 3 kΩ, for example.

The control circuit 30 may also further comprise a light emitting device voltage input circuit 60 coupled to each of a light emitting device input terminal 62A-F. The voltage input circuit 60 provides an input voltage to a plurality of light emitting devices having a first terminal coupled to a respective light emitting device input terminal 62A-F, and a second terminal coupled to a respective light emitting device output terminal 42A-F. The voltage input circuit 60 comprises a resistor R8 coupled to a voltage input V₃ and the base of an NPN BJT transistor Q7 64, and the collector of transistor Q7 64 is coupled to a voltage input V_{cc2} 66. The voltage input V₃ is configured to receive a voltage signal in the range of from about 0 V to about 10 V. The base of a darlington circuit 68 is coupled to the emitter of transistor Q7 64, and the collector of the darlington circuit 68 is coupled to voltage input V_{cc2} 66. The emitter of the darlington circuit 68 is the output of the voltage input circuit 60 and is coupled to the light emitting device input terminals 62A-F in parallel.

The control circuit 30 may also comprise a voltage regulator 70 configured to provide a regulated voltage to the components of the control circuit 30, wherein the voltage regulator 70 can be implemented, for example, with the ON Semiconductor Micropower Voltage Regulator 78LC33HT1. A voltage input V_{cc} 72 is coupled to a zener diode 74, which is coupled to an input voltage terminal 76 of the voltage regulator 70, and the input voltage terminal 76 is also coupled to ground through a 1 μF capacitor C1 78. Voltage input V_{cc} 72 can be coupled to a power source such as a 6 volt DC battery. Exemplary voltage input (V_{cc}) signal levels may be selected by skilled artisan for specific applications; preferably, such signal levels may be between about 3 V and about 9 V. The voltage regulator 70 outputs a regulated voltage to the programmable control processor 20 via an output terminal 80 coupled to an input terminal V_{DD} 82 of the programmable control processor 20. The regulated voltage level may be, for example, about 3 V, and more preferably about 3.3 V, and the voltage regulator can be configured to output a voltage of about 3 V, and more preferably about 3.15 V, upon reset.

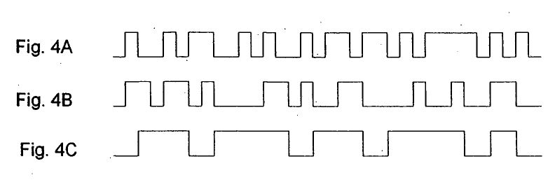

As described in regard to the electronic lighting device 8 of FIG. 2, the switch 24 has three selectors, wherein each selector has a respective output 82A-C coupled to one of three inputs 84A-C at the programmable control processor 20, and each selector has a respective input 86A-C coupled to ground. As discussed above in regard to the electronic lighting device 8, the programmable control processor 20 generates voltage signals at outputs 32A-F in response to the position of each of the three selectors of the switch 24 as detected at the inputs 84A-C of the programmable control processor 20. In response to a high voltage signal output at one of the outputs 32A-F of the programmable control processor 20, the corresponding transistor Q1-6 54A-F is turned on, thereby completing the circuit between the light emitting device voltage input circuit 60, the corresponding light emitting device input terminal 62A-F, the corresponding light emitting device output terminal 42A-F, and ground. Accordingly, a light emitting device coupled to the first pair of light emitting device input and output terminals 62A, 42A, for example, turns on or emits light in response to a high voltage signal output at the first output terminal 32A of the programmable control processor 20. The configurations of the voltage signals generated at the outputs 32A-F of the programmable control processor 20 will be discussed in further detail hereinafter below in reference to FIG. 4.

In the embodiment illustrated in FIG. 3, the control circuit 30 further comprises a supervisory circuit 90 including a voltage input terminal 82 coupled to the output voltage terminal 80 of the voltage regulator 70. The supervisory circuit 90 is configured to detect irregularities in the output voltage from the voltage regulator 70 and reset the programmable control processor 20 via a reset output 92 from the supervisory circuit 90 coupled to an \overline{MCLR} input terminal 94 of the programmable control processor 20.

The programmable control processor 20 also receives an oscillator or clock_in input signal at a CLKIN input terminal 96, which is coupled through a resistor R7 98 to the output voltage terminal 80 of the voltage regulator 70. The CLKIN input terminal 96 is also coupled to ground through a capacitor C5 99. Resistor R7 may have a value of about 3 kΩ and capacitor C5 may have a value of about 0.01° F., for example. The programmable control processor 20 may be configured to use the signal received at the CLKIN input terminal 96 to generate a clock signal. This clock signal may be used as a reference in outputting control signals at the outputs 32A-F, wherein the base clock frequency for the control signals generated at the outputs 32A-F is preferably about 200 Hz. Other frequencies may be used, as will be appreciated by those skilled in the art. Additional aspects of the control circuit 30 illustrated in FIG. 3, such as additional capacitors, resistors, and ground connections, are familiar to those skilled in the art and are therefore not discussed in additional detail herein. In addition, those skilled in the art will appreciate that the components described in connection with the electronic lighting device are exemplary in nature, and equivalent components or combinations thereof are within the scope of the invention.

In one embodiment, the control circuit 30 may be configured to generate eight different lighting effects by generating eight different combinations of control signals for the light emitting devices configured to receive the control signals. The control signals may be generated by the programmable control processor 20 according to a 4 byte random number, for example, and the positions of the selectors of the switch 24. In one embodiment, the programmable control processor 20 may be configured to generate eight different lighting effects by producing eight sets of three control signals for the three light emitting devices 14, 16, 18. In one embodiment, the eight different lighting effects may comprises three flicker effects corresponding to a flame in very turbulent air, a flame in moderately turbulent air, and a flame in minimally turbulent air. A fourth lighting effect may be referred to as a full random effect wherein one of the flicker effects is randomly selected and executed a random number of times. These four lighting effects may be further varied by generating a dimmed or reduced intensity version of each, thereby constituting eight total lighting effects. Each of the eight effects is selectable by a user by positioning the selectors of switch 24, for example, where the position of a first selector determines whether a normal intensity or un-dimmed effect is selected, and the positions of the remaining two selectors determine which of the three flicker effects or full random effect is selected. Instead of or in addition to the full random effect, a predetermined sequential effect may be implemented. Preferably, for such an effect, a predetermined choice of the available flicker effects may be selected and executed for a predetermined time period.

In one embodiment, the programmable control processor 20 has direct ON/OFF control of each of the light emitting devices 14, 16, 18 via light emitting device input terminals 62A-C and light emitting device output terminals 42A-C, for example. The light emitting devices 14, 16, 18 may be controlled based on a software driven algorithm to generate the plurality of lighting effects, such as those discussed above. In one embodiment, the lighting effects are based on two different basic effects: a blink effect and an “ALL ON” effect.

The blink effect preferably comprises a random ON/OFF sequence for each light emitting device and is configured to simulate the motion of a real candle flame. FIGS. 4A-C depict exemplary timing diagrams illustrating one embodiment of a plurality of control signals generated by control circuit 30 and provided to a plurality of light emitting devices, such as the light emitting devices 14, 16, 18 of FIG. 2. The lighting effect illustrated in FIGS. 4A-C may be referred to as a blink effect.

The control signals are described herein with respect to the light emitting devices 14, 16, 18 of the electronic lighting device 8, wherein only three light emitting devices are coupled to the control circuit 30 but will be understood to relate to other arrangements as well. FIG. 4A illustrates one embodiment of a control signal for the upper light emitting device 18, FIG. 4B illustrates one embodiment of a control signal for the middle light emitting device 16, and FIG. 4C illustrates one embodiment of a control signal for the lower light emitting device 14.

As illustrated by the control signal of FIG. 4A, the upper light emitting device 18, representing the tip of the candle flame, may be turned on and off at random intervals, according to a random number that may be generated at the programmable control processor 20. The upper light emitting device is illuminated, for example, on the average, approximately half the time as a consequence of the random on-and-off nature of the control signal. The control signals for the lower and middle light emitting devices are preferably in the logical high state a greater proportion of the time. In addition, the average time period between successive high logic states, may be set to decrease between the upper light emitting device and the lower light emitting device. Accordingly, the lower light emitting device may be illuminated the majority of the time with only relatively occasional and brief periods during which it is off, as illustrated in FIG. 4C. Thus, the flicker rate of the lower light emitting device may nevertheless be sufficiently high that it appears to flicker between a bright state and a substantially less bright state, rather than flickering distinctly on and off.

Similar to the lower light emitting device, in a preferred embodiment, the middle light emitting device may also be illuminated the majority of the time, but not as often as the lower light emitting device as illustrated in FIG. 4B. In addition, the middle light emitting device may have relatively longer and more frequent periods during which it is not illuminated. Because of the relatively high average frequency of the control signal, the middle light emitting device may, thus, appear to flicker between an intermediate intensity level and a substantially higher intensity level, wherein the average rate of flicker for the middle light emitting device is relatively greater than that of the lower light emitting device. The upper light emitting device may thus appear to flicker on and off more distinctly than either the lower or middle light emitting devices, wherein the average length of the periods during which the upper light emitting device is illuminated and not illuminated are approximately equal in duration, and wherein the duration of the periods in which the upper light emitting device is not illuminated are, on the average, longer than the average periods during which the lower and middle light emitting devices are not illuminated.

The net result may therefore be a set of two, preferably three, or more than three light emitting devices which simulate both the illumination intensity distribution and the gas turbulence of a natural flame. The average illumination intensity increases toward the base of the device, thus simulating the actual intensity distribution in a flame, which occurs as a result of the greater combustion rate near the base of the flame. In addition, the flickering effect may be configured to be more pronounced toward the top of the flame, thus simulating the greater gas turbulence that may exist near the top of a flame.

The control signals generated by the control circuit 30 control both the periodicity and intensity of illumination of the light emitting devices 14, 16, 18. The upper, middle, and lower light emitting devices preferably have a higher, average, and lower probability of turning on or toggling, respectively. In one embodiment, the programmable control processor 20 randomly evaluates each of the light emitting devices for a change of state (toggle) about every 5 milliseconds. In one exemplary embodiment, the blink effect sequence has a duration of preferably about 30 milliseconds, or about 10 milliseconds, about 20, about 40, about 50 milliseconds and the blink effect sequence maybe generated in a substantially infinite loop, wherein a new random number is generated before each sequence is executed.

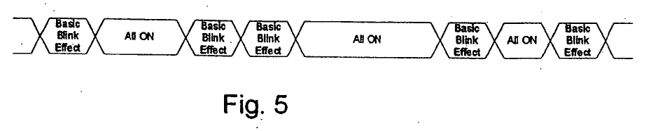

The flicker effect may be configured to simulate the effect of still and variant levels of turbulent air on a candle flame. At the beginning of a flicker effect sequence, the programmable control processor 20 may be configured to randomly execute either the blink effect described above, or activates all light emitting devices for a random period of time (termed an ALL ON effect). An exemplary timing diagram for the flicker effect, comprising different durations of each the blink effect and the ALL ON effect are illustrated in FIG. 5. The duration of a flicker effect sequence is based at least in part on the probability that the blink effect is executed versus the ALL ON effect, and the probability of each is determined based at least in part on the selected level of air turbulence. If the probability for the ALL ON effect is high, the overall lighting effect will be that of a flame in still or minimally turbulent air. If the probability for the ALL ON effect is low, the overall lighting effect will be that of a flame in very turbulent air.

Thus, the selection of one of the three flicker lighting effects according to the position of a subset of, preferably two of the three, selectors at the switch 24 and this selection corresponds to differing probabilities of the ALL ON effect as determined at the programmable control processor 20. In one embodiment, a low flicker or minimally turbulent air lighting effect is generated when, for example, the first and second selectors of the switch 24 are in an ON position, wherein a probability for the ALL ON effect at the programmable control processor 20 is high. A moderate flicker or moderately turbulent air lighting effect may be set to be generated when, for example, the first selector of the switch 24 is in an ON position and the second selector is in an OFF position, wherein a probability for the ALL ON effect at the programmable control processor 20 is moderate. A high flicker or very turbulent air lighting effect may be set to be generated when, for example, the first selector of the switch 24 is in an OFF position and the second selector is in an ON position, wherein a probability for the ALL ON effect at the programmable control processor is low.

As mentioned above, for a full random lighting effect the control processor 20 may be configured to randomly select one of the flicker effects and executes it over a random number of times or for a random duration of time. This full random lighting effect may be generated when, for example, the first selector of the switch 24 is in an OFF position and the second selector switch is in an OFF position. The control processor 20 selection of a flicker effect and execution for a random time period is repeated in a substantially infinite loop. The full random lighting effect provides a realistic simulation of a candle in variable or changing air turbulence.

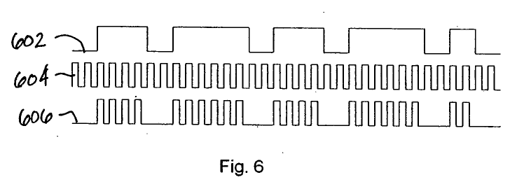

A dimmed or reduced intensity version of each of the flicker and full random lighting effects is also selectable, according to the selector positions at the switch 24. In one embodiment, when the third selector of the switch 24 is in an ON position, a dimmed or reduced intensity version of the lighting effect generated in accordance with the positions of the first and second selectors of the switch 24 is generated at the light emitting devices 14, 16, 18. For example, when all of the selectors of the switch 24 are in the ON position, a dimmed or reduced intensity version of the low flicker or minimally turbulent air lighting effect is generated. In another embodiment, the control processor 20 generates the dimmed or reduced intensity lighting effects by adding a pulse width modulated (PWM) voltage signal to the control signals generated for each lighting device. FIG. 6 illustrates exemplary timing diagrams of a light emitting device control signal 602, a PWM signal 604, and a signal generated as a sum of the light emitting device control signal and the PWM signal, or a sum control signal 606. As the light emitting device receiving the sum or dimmed control signal turns on and off according to the control signal, the light emitting device generates a reduced intensity light substantially equivalent to about ⅔ the intensity of the regular light intensity generated by the light emitting device.

In one embodiment, the algorithms executed by the control processor 20 spend a majority of their processing time in wait loops, and the control processor 20 can therefore use the wait periods to alternate the light emitting devices between their programmed state according to the blink effect or the ALL ON effect, and an ALL OFF state according to the sum or dimmed control signal. In one embodiment, the PWM duty cycle is fixed in software at the control processor 20 at about 50%, which provides a close approximation of about 6 V operation when voltage supply of about 9V is used. The duty cycle is preferably easily adjustable if more or less dimming is desired.

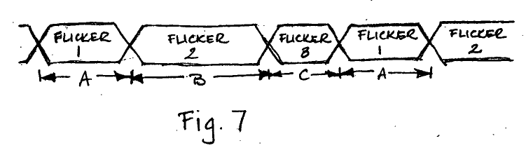

In place of or in addition to the full random lighting effect, one embodiment of the electronic lighting device 8 is configured to generate a predetermined lighting effect, comprising generation of at least two of the lighting effects discussed above, each for a predetermined time period and in sequence, and further repeated in a substantially infinite loop. This sequential flicker effect may also include generation of any combination of the flicker lighting effects, full random lighting effect, and dimmed and un-dimmed versions of each of these lighting effects. FIG. 7 illustrates an exemplary timing diagram of a sequential lighting effect, comprising generation of a first flicker effect, second flicker effect, and third flicker effect for predetermined time periods, wherein the total of the three lighting effects is repeated in a substantially infinite loop. Wherein the first flicker effect is generated for a time period A, the second flicker effect is generated for a time period B, and the third flicker effect is generated for a time period C, the total time period for the sequential lighting effect in each repetition is A+B+C. The sequential lighting effect may be advantageous for use in electronic lighting devices employed in theatrical productions, for example.

The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

What is claimed is:

1. An electronic lighting device configured to simulate a natural flame, comprising:
a plurality of light emitting devices;
control circuitry coupled to the plurality of light emitting devices and configured to control the illumination of the plurality of light emitting devices to produce a plurality of lighting effects,
wherein the plurality of lighting effects are configured to produce at least a first lighting effect, and a second, different lighting effect in sequence, wherein the sequence is repeated.

2. The electronic lighting device of claim 1, wherein the control circuitry is coupled to a selection device such that the lighting effect produced is selectable by a user.

3. The electronic lighting device of claim 2, wherein the selection device is a switch having a plurality of user selectable positions.

4. The electronic lighting device of claim 1, wherein the plurality of light emitting devices are arranged in a substantially vertical configuration.

5. The electronic lighting device of claim 4, and wherein the illumination intensity of an uppermost light emitting device is less than the illumination intensity of a lower light emitting device.

6. The electronic lighting device of claim 4, wherein the control circuitry is configured to control the illumination of the plurality of light emitting devices such that an uppermost light emitting device is illuminated less frequently than a lower light emitting device.

7. The electronic lighting device of claim 1, wherein a subset of the plurality of light emitting devices is configured for illumination in response to signals from the control circuitry.

8. The electronic lighting device of claim 1, wherein the plurality of light emitting devices comprises at least two subsets of light emitting devices, wherein illumination of each subset of light emitting devices simulates at least two natural flames.

9. The electronic lighting device of claim 1, wherein the sequence has a predetermined time duration comprising a predetermined time duration for the first lighting effect and a predetermined time duration for the second lighting.

10. A method of simulating a natural flame, comprising periodically illuminating a plurality of light emitting devices to produce a plurality of lighting effects, wherein the plurality of lighting effects comprises at least a first lighting effect and a second, different lighting effect in sequence, wherein the sequence is repeated.

11. The method of claim 10, wherein the lighting effect is selected.

12. The method of claim 11, wherein a switch having a plurality of user selectable positions is used to select the lighting effect.

13. The method of claim 10, wherein the plurality of light emitting devices are arranged in a substantially vertical configuration.

14. The method of claim 13, wherein the illumination intensity of an uppermost light emitting device is less than the illumination intensity of a lower light emitting device.

15. The method of claim 13, wherein the uppermost light emitting device is illuminated less frequently than a lower light emitting device.

16. The method of claim 10, wherein the sequence has a predetermined time duration comprising a predetermined time duration for the first lighting effect and a predetermined time duration for the second lighting.

17. The method of claim 10, further comprising simulating a plurality of natural flames, wherein the plurality of light emitting devices comprises a plurality of subsets of light emitting devices, wherein each subset of light emitting devices is configured to simulate a natural flame, and wherein the method further comprises illuminating each subset of light emitting devices to produce a plurality of lighting effects at each subset.

18. The method of claim 10, wherein a subset of the plurality of light emitting devices are illuminated to produce the plurality of lighting effects.
